(19) United States
(12) Patent Application Publication
(10) Pub. No.: US 2026/0246049 A1
(43) Pub. Date: Aug. 20, 2026

(54) Flat Battery Holder Having Magnetic Retaining Feature

(71) Applicant: Tools Aviation, L.L.C., Oswego, IL (US)

(72) Inventor: Richard W Foreman, Wayne, IL (US)

(73) Assignee: Tools Aviation, LLC, Oswego, IL (US)

(21) Appl. No.: 19/177,562

(22) Filed: Apr. 12, 2025

Related U.S. Application Data
(60) Provisional application No. 63/633,544, filed on Apr. 12, 2024.

(51) Int. Cl. H01M 50/216; H01M 50/262; H01M 50/291

(52) U.S. Cl. CPC H01M 50/216; H01M 50/262; H01M 50/291

(57) ABSTRACT

A battery holding and dispensing device can hold a plurality of coin batteries. The battery holding and dispensing device includes a body having a plurality of compartments, or a single channel, sized and shaped to each receive a coin battery and the body having one or more magnetic inserts for releasably retaining the battery in the compartment. Alternately the body has a mechanical device to hold the coin batteries into the body at opposite ends.

This application claims the benefit of U.S. Provisional Patent Application No. 63/633,544, filed Apr. 12, 2024.

### BACKGROUND

Thin, flat, cylindrical batteries are sometimes referred to as “coin batteries.” These types of batteries are commonly used in small appliances, remote controls wrist watches and other items. One such battery has a size indicator of “CR2032.”

Given the fact that these batteries are small, the present inventor has recognized that it would be advantageous to provide a battery holder wherein the batteries can be dispensed as needed.

### SUMMARY

An exemplary embodiment of the invention provides a flat battery holder and dispensing apparatus, such as for coin batteries. The holder includes a battery holding body for holding and releasably retaining plural flat batteries. The body includes open ends from which batteries can be dispensed. The body can include a base wall portion and on one face side of the base wall are two L-shaped members extending from the opposite edges of the base wall portion extending away from the base wall portion. On the face side of the base wall portion, the L-shaped members are spaced from each other and oriented in mirror image fashion across a longitudinal centerline of the base wall portion. The L-shaped members capture opposite edge portions of a coin battery held against the face side of the base wall portion, within the body, but allows the coin battery to be slid longitudinally along the base wall portion and through channels formed between the base wall portion and the L-shaped members. The channels on the face side of the base wall portion are open at longitudinal ends to allow removal of a coin battery from either end. Alternately, the channels can be open at only one end. The body can hold four batteries, but more or fewer batteries can be held depending on the chosen length of the body.

The holder can also include two battery holding bodies, each of which are as described above, the two bodies secured together back-to-back to hold eight batteries. Once secured together, the holder has a base wall, a laminate of the two base wall portions, and on each face side of the base wall, are two L-shaped members extending from the opposite edges of the base wall away from the base wall. On each exposed face side of the base wall, the L-shaped members are spaced from each other and oriented in mirror image fashion across a longitudinal centerline of the base wall. The L-shaped members capture opposite edge portions of a flat battery held against the face side of the base wall, within the body, but allows the flat battery to be slid longitudinally along the base wall and through channels formed between the base wall and the L-shaped embers. The channels on each face side of the base wall portion are open at longitudinal ends to allow removal of a flat battery from either end. Alternately, the channels can be open at only one end. The holder can hold eight batteries, but more or fewer batteries can be held depending on the chosen length of the body.

At least one magnet is carried by the base wall or base wall portion in a manner to magnetically retain a flat battery against the base wall. In one embodiment, the holder holds four coin-batteries on each face side and a plurality of magnets along the base wall hold the coin batteries in the holder. The strength of the magnets is such that force from a user's finger or thumb on an exposed surface of a coin battery between the L-shaped members on each face side to slide the coin battery toward an open end of the holder overcomes the magnetic force to eject the coin battery from the holder. In the four-battery holder or eight-battery holder, two spaced-apart magnets are sufficient to hold four batteries on one or both face sides within the holder. Other numbers of magnets can be used and the invention is not limited to two magnets. For example, it would also be possible to have magnets only on opposite ends of the base wall to retain end batteries from falling out of the holder. It would also be possible to have only one end of the channels open and have a single magnet near to the open end.

One embodiment holder is assembled by forming two battery holding bodies each having a base wall portion and the L-shaped channels as described above but only on one face side of the base wall portion. The base wall portions of two of the bodies are secured back-to-back, to form a laminated base wall, with the L-shaped channels located on opposite face sides of the base wall. Before the base wall portions are secured together, the magnets are captured between the facing face sides of the two base wall portions by the one base wall portion having spaced-apart first recesses that are in registry with spaced-apart second recesses of the opposite base wall portion. The first and second recesses can also have openings through the base wall portions to expose the magnets to the flat batteries within the holder. The base wall portions can be secured together by adhesive or by screws or other known means.

Alternate to having magnets, the battery holding and dispensing apparatus can have one or more mechanical devices such as detents to hold batteries within the holder.

The battery holding and dispensing apparatus for flat batteries can include:
a body including a plurality of compartments, each compartment configured to receive a battery substantially within the compartment, and the body having an open end for dispensing the battery out of the body;
the body comprises one or more magnetic inserts, located within the compartment, or mounted to the compartment, or adjacent to the compartment to releasably retain the battery by magnetic force in the compartment.

A battery holding and dispensing apparatus for flat batteries, can include:
a body having at least one longitudinal channel configured to receive a battery at least partially within the channel, and the channel having an open end for dispensing the battery out of the channel;
the body comprises a detent adjacent to the open end, to retain the battery withing the channel, the detent being resiliently displaceable to push a battery through the open end by force from a user's thumb or finger.

A battery holding and dispensing apparatus for flat batteries, can include:
a body including at least one channel, configured to receive a battery within the channel, and the channel having an open end for dispensing the battery out of the body; the body comprises one or more magnetic inserts, located within the channel, or mounted on or in the body adjacent to the channel, to releasably retain the battery by magnetic force in the channel.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is a top perspective view of an exemplary embodiment battery holder according to the invention;

FIG. 2 is a plan view of the holder of FIG. 1;

FIG. 3 is a front view of the holder of FIG. 1; FIG. 4 is a right end view of the holder of FIG. 1;

FIG. 5 is an exploded perspective view of the holder of FIG. 1;

FIG. 6 is a sectional view taken through plane 6-6 of FIG. 4;

FIG. 7 is a plan view of the holder of FIG. 1, loaded with batteries;

FIG. 8 is a schematic, fragmentary, perspective view of an alternate embodiment battery holder;

FIG. 9 is a right end view of the holder of FIG. 8;

FIG. 10 is an end view of an alternate embodiment holder; and

FIG. 11 is a bottom view of the holder of FIG. 10.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

This application incorporates by reference U.S. Provisional Patent Application No. 63/633,544, filed Apr. 12, 2024.

The caddies can be plastic, made by injection molding. The plastic can be polypropylene or polycarbonate. The plastic can be a phosphorescent resin such as a Resin Series 100(PP) polypropylene or Series 300(PC) polycarbonate available from RTP Company of Winona, Minnesota, US. The phosphorescent resin gives the caddies a glow-in-the-dark feature.

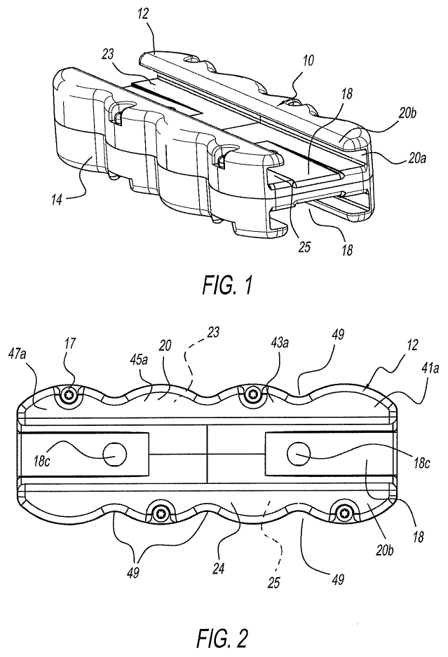

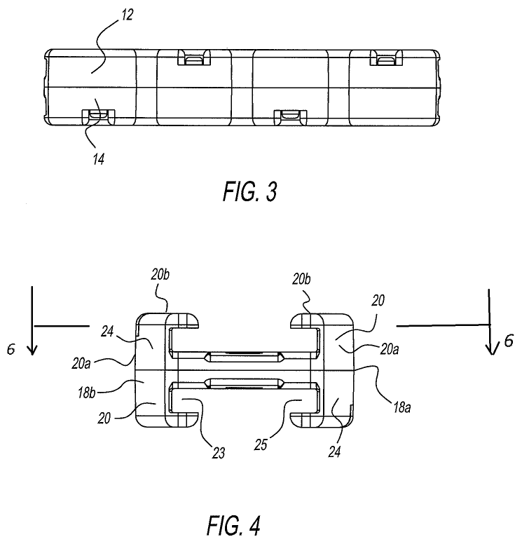

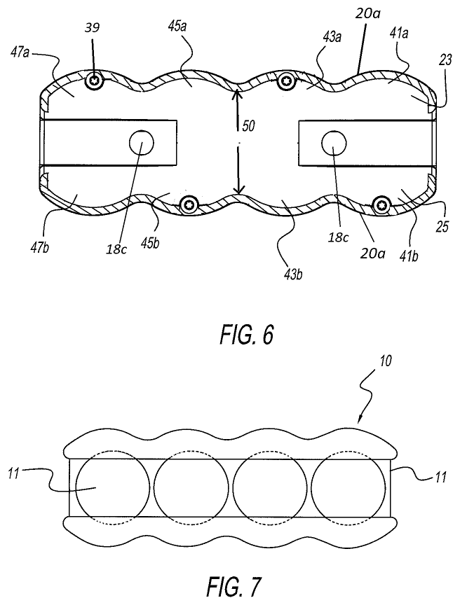

FIGS. 1-7 illustrate a battery holder 10 that is sized to hold eight coin-batteries 11; four batteries on opposite exposed face sides of the holder.

The illustrated holder includes two separate bodies 12, 14 that are substantially identical and secured together back-to-back.

Although in the illustrated holder 10, two bodies are secured to form one holder 10, it is to be understood that the bodies 12, 14 could represent two separate holders, each holding four batteries and used as two separate holders.

Each body 12, 14 includes a base wall portion 18 and L-shaped members 20, 24 that have a first leg 20a that extends perpendicularly from longitudinal opposite edges 18a, 18b of the base wall portion 18 and a contiguous second leg 20b that extends perpendicularly from the first leg 20a and toward the respective other L-shaped member. The L-shaped members 20, 24 are L-shaped in cross section along their longitudinal length. The base wall portion 18 has an undulating width along a length of the base wall portion approximately equal to, or greater than, a diameter of a battery held on the base wall portion 18. The L-shaped members 20, 24 form channels 23, 25 with the base wall portion along the opposite edges 18a, 18b of the base wall portion 18. The channels are sized to capture opposite edge portions of the coin battery to slidably hold the coin battery against the base wall portion.

The base wall portions 18 include a plurality of spaced-apart recesses 30 to receive a corresponding number of magnets 36. The recesses can be circular or rectangular. The recesses 30 are open on a first face 31 of the base wall portion that is opposite the L-shaped members 20, 24. The recesses are closed on a second face 33 of the base wall portion 18 on the same side as the L-shaped members 20, 24, except for small openings 18c through the base wall portion.

The bodies 12, 14 are substantially identical. The bodies 12, 14 are assembled by placing the magnets 36 into the recesses 30 of one body 12 which are in registry with the recesses 30 of the other body 14. The bodies are oriented back-to-back and secured together by adhesive, or by screws 39. For screws, each body 12, 14 includes countersunk holes 17 for receiving the screws. Each magnet 36 is fit into the corresponding two recesses of two bodies 12, 14 that are in registry. In other words, for four total recesses of the two bodies 12, 14 two batteries fill those recesses. When the bodies 12, 14 are secured together, the magnets are captured within the base wall portions of both bodies 12, 14 and between the second faces of the bodies 12, 14. The small openings 18c of the recesses allow the magnets to be partially exposed through both base wall portions 18 of the bodies 12, 14. This exposure increase the magnetic holding force between the magnets 36 and the batteries 11.

The opposite edges 18a, 18b of the base wall 18 and each L-shaped member can be undulating in shape (in plan view) with eight semicircular regions, semicircular regions 41a, 43a, 45a, 47a of L-shaped member 20 and semicircular regions 41b, 43b, 45b, 47b of L-shaped member 24. Between laterally opposing semicircular regions 41a-41b, 43a-43b, 45a-45b, 47a-47b, in a longitudinal direction, are transition regions 49 which have a narrower lateral clearance width 50 than the lateral clearance width between opposing semicircular regions 41a-41b, 43a-43b, 45a-45b, 47a-47b. The narrower clearance width 50 allows passage of batteries along the longitudinal direction of the channels 23, 25 but provides a slight gripping of the battery during sliding movement of the battery within the channels 23, 25 through the transition regions 49.

The battery fits more loosely within the opposed semicircular regions. The opposed semicircular regions, in effect, form compartments for the batteries.

Alternately, the opposite edges 18a, 18b of the base wall 18 and each L-shaped member can be straight (in plan view), rather than undulating in shape. Accordingly, the channels 23, 25 would have a constant cross-sectional area along the longitudinal direction and there would be no discernable “compartments.”

The magnets 36 can be longitudinally located within the transition regions 49. This way each magnet 36 can effectively hold two batteries on each face side of the holder.

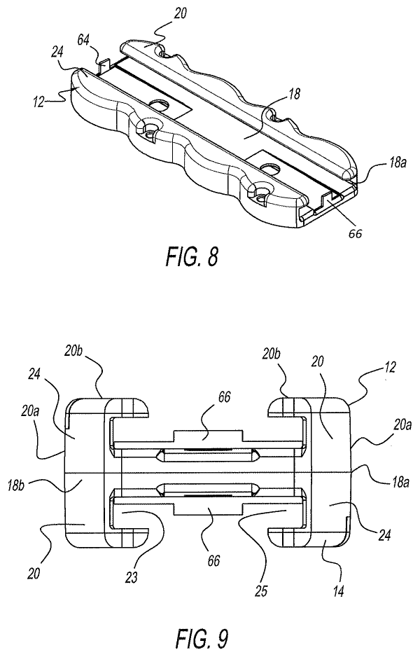

FIGS. 8 and 9 disclose an alternate embodiment wherein the magnets have been replaced by a mechanical retention device. FIG. 8 only shows one body 12 for ease of description. An opposite body 14 would be identically configured and attached back-to-back to the body 12 as per FIG. 4. For example, flexible detent 64, 66 can be added at each end of the base wall portion 18. The detents oppose removal of a battery at opposite ends of the channels 23. 25 of the body. The detents can be molded into the base wall portion 18 or can be attached to the base wall portion. Alternately, the detents can be formed into the L-shaped members, protruding from either leg 20a, 20b at opposite ends of the channels 23. 25. Other mechanisms of holding batteries within the channels include bumps in the L-shaped members or on the base wall portion, or a narrowed clearance between the L-shaped members legs 20a, or between the base wall portion 18 and the legs 20b at opposite ends of the channels.

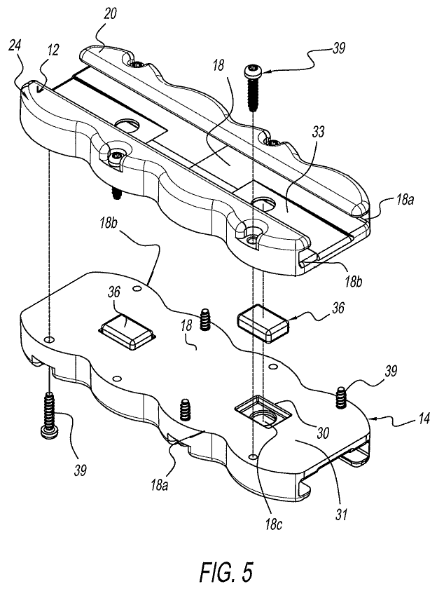

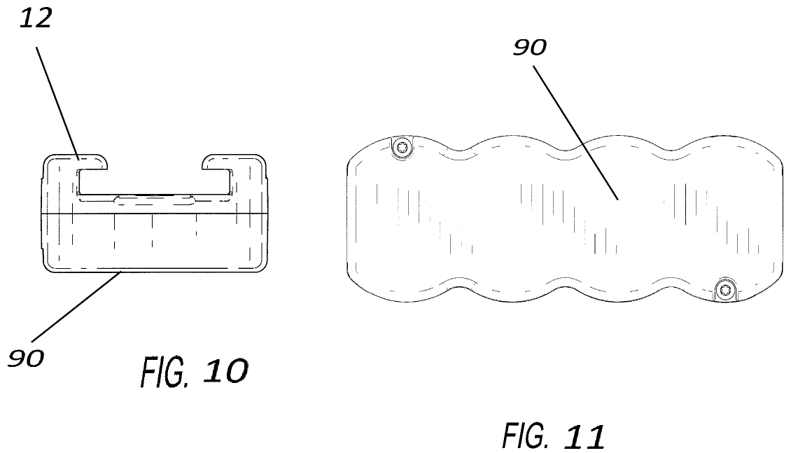

FIGS. 10 and 11 illustrate an alternate embodiment wherein, instead of providing identical bodies 12 fastened back-to-back, one of the bodies is replaced with a flat wall or block 90, having flat faces and having the same outer perimeter as a body 12. According to this embodiment the flat wall 90 is fastened to the body 12 using fasteners in the same way as would a back-to-back body be fastened as per FIG. 5. The wall 90 provides the recesses 30 for receiving batteries 36 in the same way as shown in FIG. 5 with regard to the back-to-back body 12. This embodiment would hold fewer coin batteries as the previously described embodiment.

Although the detailed description describes a holder for coin batteries, the holder could be sized to hold plug batteries as well.

From the foregoing, it will be observed that numerous variations and modifications may be utilized without departing from the spirit and scope of the invention. It is to be understood that no limitation with respect to the specific apparatus illustrated herein is intended or should be inferred.

1. A battery holding and dispensing apparatus for flat batteries, comprising:
a first body including a plurality of compartments, each compartment configured to receive a battery substantially within the compartment, and the first body having a first open end for dispensing the battery out of the first body;
the first body comprises one or more magnetic inserts, located within the compartment, or mounted to the compartment, or adjacent to the compartment, to releasably retain the battery by magnetic force in the compartment.

2. The holding and dispensing apparatus of claim 1, wherein the compartments are shaped to releasably hold one flat battery.

3. The holding and dispensing apparatus of claim 2, wherein the flat battery is a coin battery.

4. The holding and dispensing apparatus of claim 1, wherein the compartments are formed by two L-shaped members carried by a base wall portion and the members are spaced apart to overhang a flat battery held on the base wall portion and to provide a clearance therebetween to allow sliding of the batteries by a human finger.

5. The holding and dispensing apparatus of claim 4, wherein the L-shaped members have an undulating profile along a direction perpendicular to the base wall portion, along opposite sides of the first body.

6. The holding and dispensing apparatus of claim 5, wherein the L-shaped members have a spacing therebetween at first ends of the L-shaped members to form said first open end.

7. The holding and dispensing apparatus of claim 4, wherein the L-shaped members have a spacing therebetween at first ends of the L-shaped members to form said first open end.

8. The holding and dispensing apparatus of claim 4, wherein the L-shaped members have a spacing therebetween at second ends of the L-shaped members to form a second open end of the first body for removing batteries.

9. The holding and dispensing apparatus of claim 1, comprising a second body identical to said first body and connected back-to-back thereto.

10. The holding and dispensing apparatus of claim 9, wherein batteries are held in recesses in base wall portions of the first and second bodies, the recesses being in registry between the first and second bodies when assembled.

11. A battery holding and dispensing apparatus for flat batteries, comprising:
a first body including at least one channel, configured to receive a battery within the channel, and the channel having a first open end for dispensing the battery out of the first body;
the first body comprises one or more magnetic inserts, located within the channel, or mounted on or in the body adjacent to the channel, to releasably retain the battery by magnetic force in the channel.

12. The holding and dispensing apparatus of claim 11, wherein the flat battery is a coin battery.

13. The holding and dispensing apparatus of claim 11, wherein the channel is formed by two L-shaped members carried by a base wall portion and the members are spaced apart to overhang a flat battery held on the base wall portion and to provide a clearance therebetween to allow sliding of the batteries by a human finger.

14. The holding and dispensing apparatus of claim 13, wherein the L-shaped members have an undulating profile along a direction perpendicular to the base wall portion, along opposite sides of the first body.

15. The holding and dispensing apparatus of claim 14, wherein the L-shaped members have a spacing therebetween at first ends of the L-shaped members to form said first open end.

16. The holding and dispensing apparatus of claim 13, wherein the L-shaped members have a spacing therebetween at first ends of the L-shaped members to form said first open end.

17. The holding and dispensing apparatus of claim 13, wherein the L-shaped members have a spacing therebetween at second ends of the L-shaped members to form a second open end of the first body for removing batteries.

18. The holding and dispensing apparatus of claim 11 wherein the channel has a second open end at an end opposite the first open end, for removing batteries.

19. The holding and dispensing apparatus of claim 11, comprising a second body identical to said first body and connected back-to-back thereto.

20. The holding and dispensing apparatus of claim 11, wherein the channel is formed by two L-shaped members carried by a base wall portion and the members are spaced apart to overhang a flat battery held on the base wall portion and to provide a clearance therebetween to allow sliding of the batteries by a human finger, and further comprising a second body identical to said first body and connected back-to-back thereto, wherein the base wall portions of the first and second bodies include recesses that are in registry when assembled and the recesses hold said batteries.

21. (canceled)

22. (canceled)

23. (canceled)

24. (canceled)

25. (canceled)

26. (canceled)

27. (canceled)

28. (canceled)

29. (canceled)

30. (canceled)
